(19) United States
(12) Patent Application Publication
(10) Pub. No.: US 2002/0144173 A1
(43) Pub. Date: Oct. 3, 2002

(54) Serial presence detect driven memory clock control

(75) Inventor: Joseph Jeddeloh, Minneapolis, MN (US)

Correspondence Address: FISH & NEAVE, 1251 AVENUE OF THE AMERICAS, 50TH FLOOR, NEW YORK, NY, 10020-1105, US

(73) Assignee: Micron Technology, Inc.

(21) Appl. No.: 09/823,602

(22) Filed: Mar. 30, 2001

(51) Int. Cl. G06F 1/04; G06F 1/06

(52) U.S. Cl. 713/501; 711/170; 711/115

(57) ABSTRACT

In a computer system, the operating speed of the memory module interface is selected in accordance with information stored in serial presence detect EEPROMs, such as the number of memory modules coupled to a memory controller of the computer system. The memory controller has clocks of various frequencies available to it to drive the memory modules. The most optimal clock is preferably chosen based on at least the number or other characteristics, such as speed, of memory modules. This permits the memory modules to be driven with a higher speed clock when, for example, there are fewer than the maximum number of memory modules present in the system.

### BACKGROUND OF THE INVENTION

This invention relates to memory clock control in a computer circuit that includes memory. More particularly, this invention relates to memory clock control based on information contained within the memory itself.

Timing budgets are especially important in the design of a computer system. To operate the computer system at a certain clock rate, many transfers of data have to be completed within a clock period. The timing budget is the allocation of that clock period to various delay components in each data transfer. The timing budget may include items such as setup time, clock skew, and propagation delay.

A computer system typically includes a CPU (central processing unit), which may be a microprocessor, and at least one memory controller which controls communications between the microprocessor and various memory components. Conventionally, memory controllers are coupled to the microprocessor with a system bus. In turn, the memory controllers provide memory components with a memory address/data bus and a memory clock which usually run at the same speed as the system bus or at a fixed multiple of the system bus.

Typically, the maximum speed of the memory address/data bus decreases as the number of memory components increases. This increase is caused by, among other things, an increase in propagation delay because of additional capacitive loading. Memory controllers are generally set to output a memory clock having a speed compatible with the maximum number of memory components that can be coupled to the microprocessor. In some applications, the speed of the memory components may change dynamically, thereby creating the need for a memory controller to change the speed of its operating address/data bus dynamically. Therefore, operating the memory controller at a speed compatible with the actual number and characteristics of memory components, such as speed, may be advantageous. Often, this is not being done.

Furthermore, memory component manufacturers usually incorporate serial presence detect EEPROMs (electrically eraseable programmable read only memories) into memory components. These EEPROMs store data such as memory size, memory type, memory features, manufacturer identification, and other information related to the memory components. Currently this stored data is not being used to set the speed of the memory address/data bus and memory clock.

In view of the foregoing, it would be desirable to provide a memory controller that selects the speed of the memory address/data bus and memory clock based on data identifying memory components which are stored in serial presence detect EEPROMs.

### SUMMARY OF THE INVENTION

It is an object of this invention to provide a memory controller that selects the speed of the memory address/data bus and memory clock based on data identifying memory components which are stored in serial presence detect EEPROMs.

In accordance with the present invention, the operating speed of a memory interface in a computer system is selectable by a memory controller that determines the number and other characteristics of memory modules. The operating speed is selectable by providing the memory controller with clocks of varying frequencies, or by generating within the memory controller, clocks of varying frequencies. Upon initialization of the computer system, the memory controller uses serial presence detect EEPROMs, which are commonly coupled to each memory module to uniquely access each memory module, to verify the presence of each memory module. Preferably, a clock with the most optimal frequency is selected in accordance with data stored in the serial presence detect EEPROMs. In one embodiment, for example, if less than a maximum number of memory modules are present, the memory controller selects a higher frequency clock to drive the memory modules during regular operation.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram of a typical computer system;

FIG. 2 is a flow chart of a preferred embodiment of a memory module initialization process according to the present invention;

FIG. 3 is a block diagram of a preferred embodiment of a memory controller coupled to memory modules according to the present invention;

FIG. 4 is a block diagram of another preferred embodiment of a memory controller coupled to memory modules according to the present invention;

FIG. 5 is a flow chart of a preferred embodiment of a memory module count process according to the present invention; and

FIG. 6 is a block diagram of a preferred embodiment of a memory controller that generates multiple clock signals according to the present invention.

### DETAILED DESCRIPTION OF THE INVENTION

The present invention selects the speed of a computer system's memory address/data bus and memory clock by using information obtained from serial presence detect EEPROMs present on memory modules. Generally, there is a serial presence detect EEPROM corresponding to each memory module. In typical PC (personal computer) applications, for example, a microprocessor boots up by accessing data from a boot ROM (Read Only Memory) such as flash memory. The microprocessor then initializes the memory controller by programming its registers.

The initialization of the memory controller is part of the BIOS (Basic Input/Output System) usually contained within the boot ROM. During the execution of the BIOS, the memory controller can be programmed with memory module parameters from the boot ROM. These memory module parameters can include the BIOS image of the types and configurations of the memory components which do not reflect the exact numbers, types, and configuration of the memory modules. However, in accordance with the present invention, the exact numbers, types, and configuration of the memory components can be detected directly by accessing serial presence detect EEPROMs incorporated in the memory components.

In a first embodiment of the present invention, a memory controller is coupled to memory modules which incorporate serial presence detect EEPROMs. Each serial presence detect EEPROM is coupled to the memory controller with a common clock line and a unique bi-directional data line. Alternatively, the serial presence detect EEPROMs can be coupled with a common bi-directional data line and a single clock line.

During the initialization of the memory controller, the memory controller checks for the presence of memory modules by transmitting a start sequence to each of the serial presence detect EEPROMs. For each memory module present in the system, an acknowledgment is sent by the serial present detect EEPROM to the memory controller.

In accordance with this embodiment of the present invention, one memory module is counted for each acknowledgment of the memory controller's transmitted start sequence. The actual number of memory modules coupled to the memory controller is counted. Consequently, the number of unique bi-directional data lines of the memory controller should equal a maximum number of memory modules that may be coupled to the controller.

In conjunction with the counting of the memory modules, the memory controller can also determine characteristics of the memory modules by reading manufacturer-supplied information from the serial detect presence EEPROMs. The manufacturer-supplied information may include the maximum operating speed of the memory module. When the memory controller has gathered all the pertinent information, it can preferably determine an optimal operating speed for the memory address/data bus.

Generally, memory controllers derive memory module clocks from a system clock provided by an off-chip oscillator or by the microprocessor. A phase-locked loop is often used to generate a specific clock required by the memory modules. In accordance with the present invention, memory module clocks of different frequencies can be generated by phase-locked loops and provided to a multiplexer. When the memory controller has determined an operating speed for the memory address/data bus, the multiplexer can be programmed to output the most appropriate memory module clock for the memory address/data bus.

In a second embodiment of the invention, each serial presence detect EEPROM is coupled to a memory controller with a common clock line and a common bi-directional data line. Each serial presence detect EEPROM may have address lines which are connected in a different binary bit pattern for each EEPROM, such that each memory module may be provided with a unique address.

During initialization of the memory controller, the memory controller checks for the presence of memory modules by transmitting a start sequence containing a unique address to each of the serial presence detect EEPROMs. For each corresponding memory module present in the system, an acknowledgment is sent by the serial presence detect EEPROM to the memory controller.

Once the number of memory modules has been counted by the memory controller, the memory controller preferably chooses an optimal operating speed of the memory modules. A memory module clock is then generated and provided to the memory modules as described, for example, in the first embodiment of the present invention.

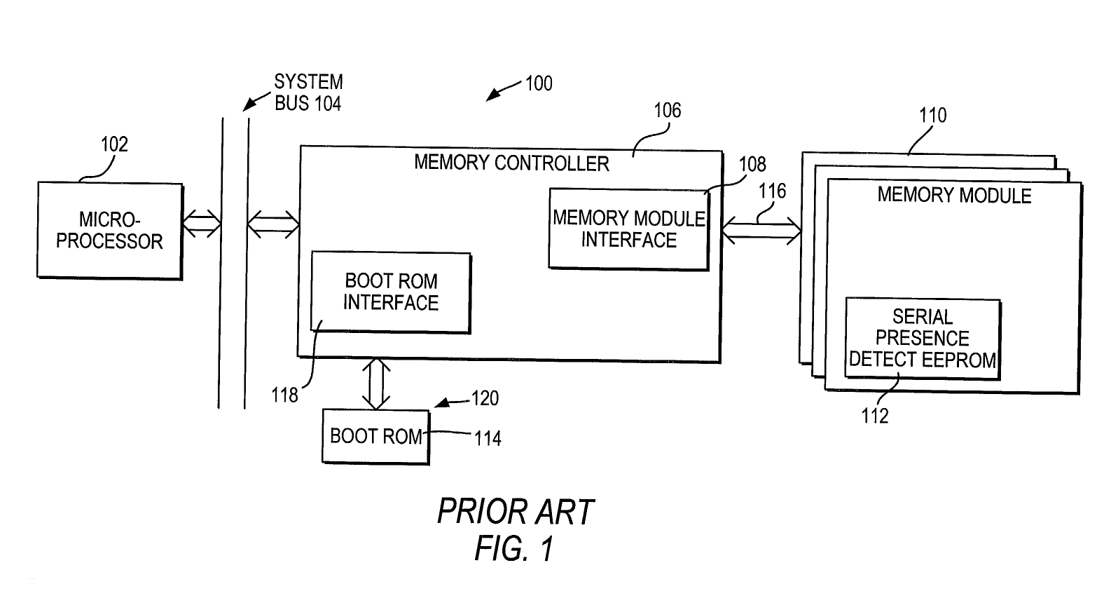

FIG. 1 shows a typical personal computer system 100. Note that the present invention is not limited to personal computer systems, but is applicable to computer systems in general. Microprocessor 102 is preferably coupled to memory controller 106 with system bus 104. Note also that in some computer systems, the memory controller may be built into the CPU. Memory controller 106 may include memory module interface 108 and boot ROM interface 118. Boot ROM interface 118 enables microprocessor 102 to access data on boot ROM 114. Data from ROM 114 are preferably transferred to microprocessor 102 via boot ROM address/data bus 120 and system bus 104. Memory interface 108 enables microprocessor 102 to access data from and write data to memory modules 110, each of which incorporates serial presence detect EEPROM 112. Data from and to memory modules 110 are preferably transferred to and from microprocessor 102 via memory address/data bus 116.

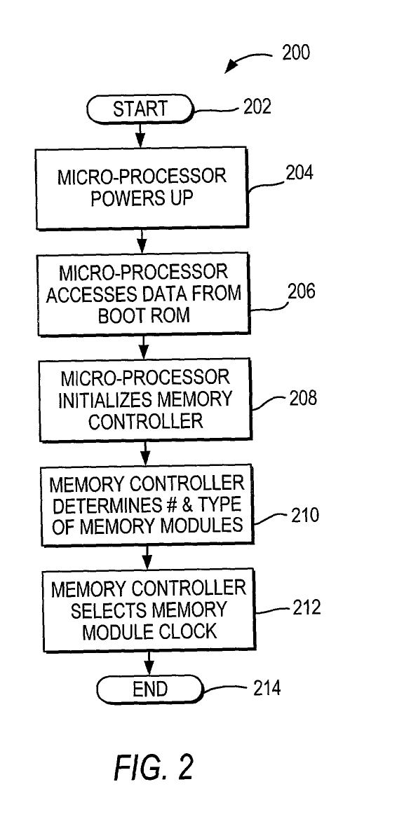

FIG. 2 shows an initialization process of memory modules 110 in accordance with the present invention. Initialization starts with the microprocessor powering up at step 204. Microprocessor 102 typically accesses instructions and other data from boot ROM 114 at step 206. Microprocessor 102 then uses that data to initialize memory controller 106 at step 208. As part of the initialization of memory controller 106, memory controller 106 accesses serial presence detect EEPROMs 112 at step 210. Memory controller 106 determines the number and types of memory modules 110 at step 212. Before ending the initialization of memory modules 110 at step 214, memory controller 106 selects an appropriate memory module clock at step 212 to be provided to memory modules 110.

In one embodiment, the memory controller compares the actual number and types of memory modules against a look-up table preferably contained within the memory controller. The look-up table can include, for example, numbers and types of memory modules corresponding to appropriate memory clock frequencies. For example, if the memory controller detects two 8-component SDRAM (Synchronous Dynamic Random Access Memory) modules, it can look that up in its look-up table and find a corresponding operating clock speed of, for example, 100 MHz. If the number of modules is four instead of two, the memory controller may instead find a corresponding operating clock speed of 83 MHz in its look-up table.

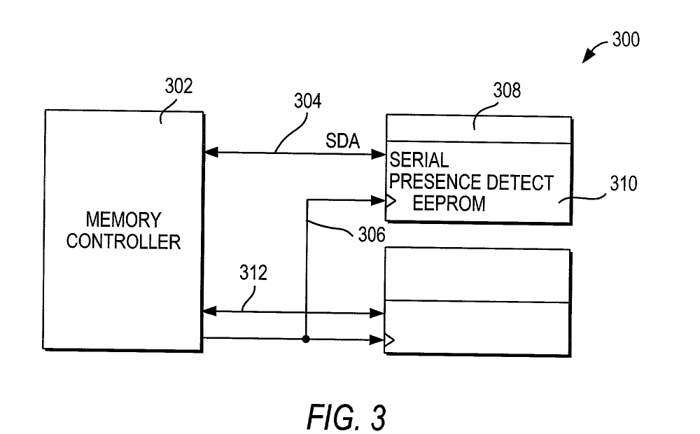

FIG. 3 shows in more detail an embodiment of serial presence detect EEPROMs 112 coupled to memory controller 106. Memory controller 302 is coupled to serial presence detect EEPROMs 310 of respective memory modules 308 by common clock line 306 and unique bi-directional data lines 304 and 312. The roles of common clock line 306 and data lines 304 can be advantageously reversed such that a single bi-directional common data line and unique clock lines will not change the functionality of the present invention.

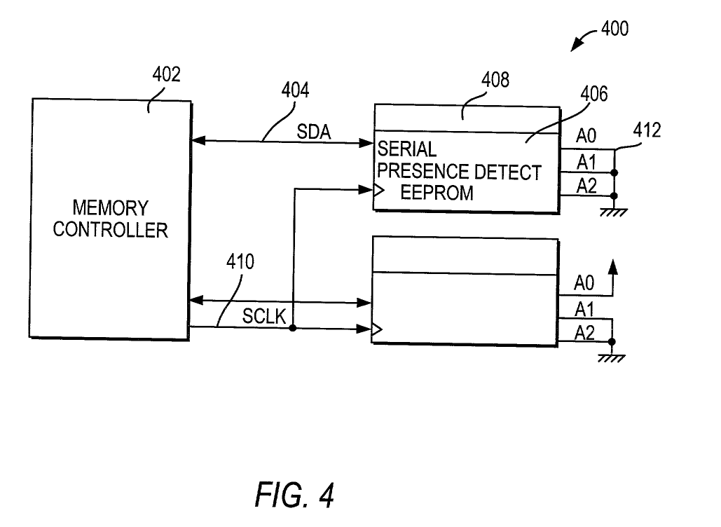

FIG. 4 shows in more detail another embodiment of serial presence detect EEPROMs 112 coupled to memory controller 106. In this embodiment, memory controller 402 is coupled to serial presence detect EEPROMs 406 of memory modules 408 with common clock line 410 and common bi-directional data line 404. Each serial presence detect EEPROM 406 has a unique address identifier provided by coupling address lines 412 alternately to ground and a power supply rail to produce unique bit patterns.

The embodiments of FIGS. 3 and 4 show that each serial presence detect EEPROM, and thus each memory module, engages in one-to-one communication with a suitably coupled memory controller. This, in turn, enables a memory controller to count each memory module and to identify other memory module characteristics.

Other characteristics useful in determining an operating clock frequency include the number of components in a memory module, the manufacturer, the speed grade of the memory module or its components, the type of memory module, and the physical layout of printed board circuit connections between the memory controller and the memory module.

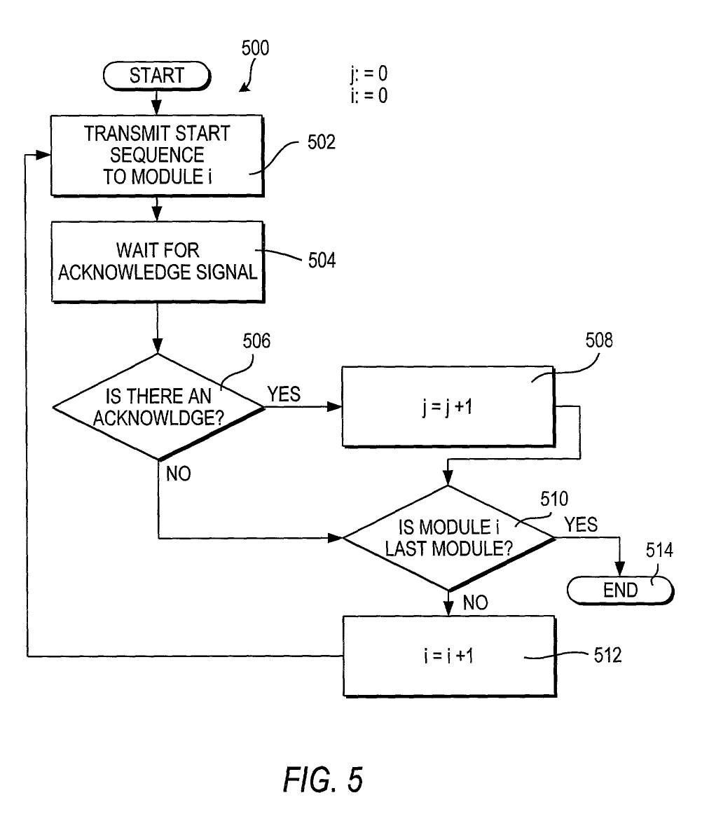

FIG. 5 shows a flow chart of a memory module count process performed by the memory controller. Variables i and j are set to zero and one, respectively. Counting starts with the transmitting of a start sequence to module i at step 502. Module i should respond in a predetermined amount of time during which the memory controller waits at step 504. If there is an acknowledgment of the start sequence at step 506, then the memory controller increments variable j at step 508, which is a running total of the number of counted memory modules. If there is no acknowledgment of the start sequence at step 506, the memory controller proceeds to step 510. At step 510, the memory controller determines whether module i is the last module. The memory controller knows the maximum number of memory modules attachable to itself and compares this number to variable i. If module i is the last module, the process ends at step 514. If not, variable i is incremented by one at step 512, before memory controller starts again at step 502 with next module i, where i=i+1. Once the memory controller has determined the number and type of memory modules coupled to itself, the memory controller preferably determines the maximum operating speed.

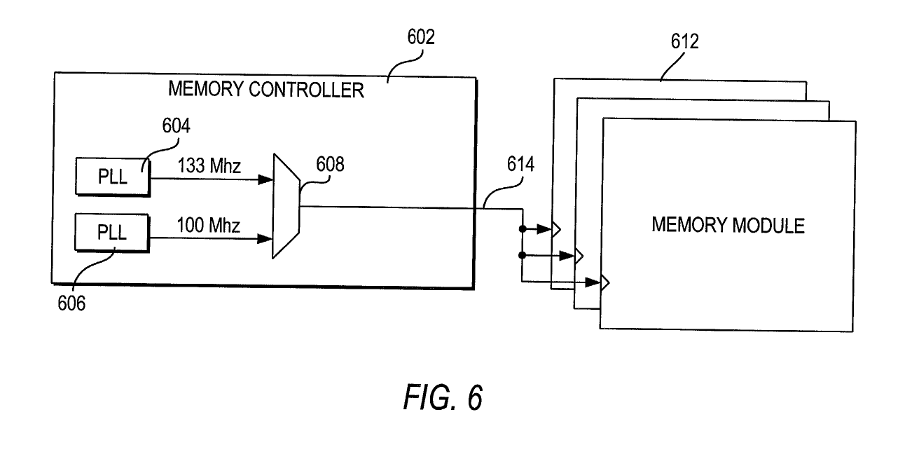

FIG. 6 shows an embodiment of the present invention in which memory controller 602 preferably includes phase-locked loops (PLLs) 604 and 606 to generate clocks of two standard frequencies—100 MHz and 133 MHz. These clocks are input to multiplexer 608. Memory module clock 614 is output from multiplexer 608 and has a frequency of 100 MHz or 133 MHz, depending on the results of the counting process shown in FIG. 5. Note that memory controller 602 can have more than two PLLs for generating clocks of other frequencies.

Generally, if there are fewer memory modules coupled to memory controller 602, a higher frequency memory module clock 614 is chosen. Other factors which may be considered include the type of memory module and the capacitive load each memory module presents. In addition to the selection of a preferably optimal memory module clock as shown in FIG. 6, the entire memory address/data bus is preferably run at the same rate as the selected memory module clock.

Thus it is seen that memory module clocks can be selected based on information stored in serial presence detect EEPROMs. One skilled in the art will appreciate that the present invention can be practiced by other than the described embodiments, which are presented for purposes of illustration and not of limitation, and the present invention is limited only by the claims which follow.

I claim:

1. A method of selecting an operating speed of a memory module interface in a computer system, said system comprising a central processing unit, a memory controller, and at least one memory module comprising a serial presence detect memory, said method comprising:
counting the number of said memory modules;
generating multiple clock frequencies to provide selectable operating speeds of said memory module interface; and
selecting one of said operating speeds of said memory module interface in accordance with said counting.

2. The method of claim 1 wherein said selecting comprises generating memory module interface signals comprising clock, address, and data signals at a frequency based on said memory module count.

3. The method of claim 1 further comprising obtaining information from said serial presence detect memory that includes at least one characteristic of said memory module, wherein said selecting comprises selecting one of said operating speeds in accordance with one of said counting and said characteristic.

4. The method of claim 3 wherein said characteristic comprises the number of components in each said memory module.

5. The method of claim 3 wherein said characteristic comprises a speed grade of said memory module.

6. The method of claim 3 wherein said characteristic comprises a manufacturer of said memory module.

7. The method of claim 3 wherein said characteristic comprises a type of said memory module.

8. The method of claim 3 wherein said characteristic comprises a physical layout of signal connections between said memory controller and said memory module.

9. A method of selecting an operating speed of a memory module interface in a computer system, said system comprising a central processing unit, a memory controller, and at least one memory module comprising a serial presence detect memory, said method comprising:
counting the number of said memory modules;
obtaining information from said serial presence detect memory that includes at least one characteristic of said memory module; and
selecting said operating speed of said memory module interface in accordance with at least one of said counting and said obtaining information.

10. The method of claim 9 wherein said characteristic comprises a type of said memory module.

11. A method of selecting an operating speed of a memory module interface in a computer system, said system comprising a central processing unit, a memory controller, and at least one memory module comprising a serial presence detect memory, said method comprising:
counting the number of said memory modules;
obtaining information from said serial presence detect memory that includes at least the number of components in each said memory module; and
selecting said operating speed of said memory module interface in accordance with at least one of said counting and said obtaining information.

12. A method of selecting an operating speed of a memory module interface in a computer system, said system comprising a central processing unit, a memory controller, and at least one memory module comprising a serial presence detect memory, said method comprising:
counting the number of said memory modules;
obtaining information from said serial presence detect memory that includes at least a speed grade of said memory module; and
selecting said operating speed of said memory module interface in accordance with at least one of said counting and said obtaining information.

13. A computer system comprising:
a central processing unit;
a memory controller including a memory module interface; and
at least one memory module including a serial presence detect memory; wherein said memory controller:
generates multiple clock frequencies;
accesses said serial presence detect memory;
keeps a running tally of the number of said memory modules based on said accesses to said serial presence detect memory; and
selects one of said clock frequencies for driving said memory module interface based on at least a final tally of the number of said memory modules.

14. The computer system of claim 13 wherein said central processing unit is a microprocessor.

15. The computer system of claim 13 wherein said memory controller obtains information from said serial presence detect memory that includes at least one characteristic of each said memory module.

16. The computer system of claim 15 wherein said characteristic comprises the number of components in each said memory module.

17. The computer system of claim 15 wherein said characteristic comprises a speed grade of said memory module.

18. The computer system of claim 15 wherein said characteristic comprises a manufacturer of said memory module.

19. The computer system of claim 15 wherein said characteristic comprises a type of said memory module.

20. The computer system of claim 15 wherein said characteristic comprises a physical layout of signal connections between said memory controller and said memory module.

21. A computer system comprising:
a central processing unit;
a memory controller including a memory module interface;
at least one memory module including a serial presence detect memory; wherein said memory controller:
accesses said serial presence detect memory;
keeps a running tally of the number of said memory modules based on said accesses to said serial presence detect memory;
obtains information from said serial presence detect memory that includes at least one characteristic of said memory module; and
provides a memory module interface at a clock rate based on at least one of a final tally of the number of said memory modules and said obtained information.

22. The computer system of claim 21 wherein said characteristic comprises the number of components in each said memory module.

23. A computer system comprising:
a central processing unit;
a memory controller including a memory module interface;
at least one memory module including a serial presence detect memory; wherein said memory controller:
accesses said serial presence detect memory;
keeps a running tally of the number of said memory modules based on said accesses to said serial presence detect memory;
obtains information from said serial presence detect memory that includes at least the number of components in each memory module; and
provides a memory module interface at a clock rate based on at least one of a final tally of the number of said memory modules and said obtained information.

24. A computer system comprising:
a central processing unit;
a memory controller including a memory module interface;
at least one memory module including a serial presence detect memory; wherein said memory controller:
accesses said serial presence detect memory;
keeps a running tally of the number of said memory modules based on said accesses to said serial presence detect memory;
obtains information from said serial presence detect memory that includes at least a speed grade of said memory modules or their components; and
provides a memory module interface at a clock rate based on at least one of a final tally of the number of said memory modules and said obtained information.

25. A computer system comprising:
a central processing unit;
at least one memory module including a serial presence detect memory; and
memory controller means including memory module interface means; wherein said memory controller means:
generates multiple clock frequencies;
accesses serial presence detect memory;
keeps a running tally of the number of said memory modules based on said accesses to said serial presence detect memory; and
selects one of said clock frequencies for driving said memory module interface means at a clock rate based on at least a final tally of the number of said memory modules.

26. A computer system comprising:
a central processing unit;
at least one memory module including a serial presence detect memory; and
memory controller means including memory module interface means; wherein said memory controller means:
accesses serial presence detect memory;
keeps a running tally of the number of said memory modules based on said accesses to said serial presence detect memory;
obtains information from said serial presence detect memory that includes at least one characteristic of said memory module; and
provides a memory module interface means at a clock rate based on at least one of a final tally of the number of said memory modules and said obtained information.

27. The computer system of claim 26 wherein said characteristic comprises a type of said memory module means.

28. The computer system of claim 26 wherein said characteristic comprises a physical layout of signal connections between said memory controller means and said memory module means.

29. A computer system comprising:
a central processing unit;
at least one memory module including a serial presence detect memory; and
memory controller means including memory module interface means; wherein said memory controller means:
accesses serial presence detect memory;
keeps a running tally of the number of said memory modules based on said accesses to said serial presence detect memory;
obtains information from said serial presence detect memory that includes at least the number of components in each memory module means; and
provides a memory module interface means at a clock rate based on at least one of a final tally of the number of said memory modules and said obtained information.

30. A computer system comprising:
a central processing unit;
at least one memory module including a serial presence detect memory; and
memory controller means including memory module interface means; wherein said memory controller means:
accesses serial presence detect memory;
keeps a running tally of the number of said memory modules based on said accesses to said serial presence detect memory;
obtains information from said serial presence detect memory that includes at least a speed grade of said memory module or its components; and
provides a memory module interface means at a clock rate based on at least one of a final tally of the number of said memory modules and said obtained information.

31. A memory controller comprising a memory module interface to at least one memory module, said memory module including serial presence detect memory; wherein said memory controller:
accesses serial presence detect memory;
keeps a running tally of the number of said memory modules based on said accesses to said serial presence detect memory; and
provides a memory module interface at a clock rate based on at least at least a final tally of the number of said memory modules.

32. The memory controller of claim 31 wherein said memory controller obtains information from said serial presence detect memory that includes at least one characteristic of said memory module wherein said clock rate is also based on said characteristic.

33. The memory controller of claim 31 wherein said characteristic comprises the number of components of said memory module.

34. The memory controller of claim 31 wherein said characteristic comprises a speed grade of said memory module.

35. The memory controller of claim 31 wherein said characteristic comprises a manufacturer of said memory module.

36. The memory controller of claim 31 wherein said characteristic comprises a type of said memory module.

37. The memory controller of claim 31 wherein said characteristic comprises a physical layout of signal connections between said memory controller and said memory module.

38. A memory controller comprising a memory module interface to at least one memory module, said memory module including serial presence detect memory; wherein said memory controller:
generates multiple clock frequencies;
accesses serial presence detect memory;
keeps a running tally of the number of said memory modules based on said accesses to said serial presence detect memory;
obtains information from said serial presence detect memory that includes at least one characteristic of said memory module; and
selects one of said clock frequencies for driving said memory module interface based on at least one of a final tally of the number of said memory modules and said obtained information.

39. The memory controller of claim 38 wherein said characteristic comprises a speed grade of said memory module.

40. A memory controller comprising a memory module interface to at least one memory module, said memory module including serial presence detect memory; wherein said memory controller:
accesses serial presence detect memory;
obtains information from said serial presence detect memory that includes at least the number of components in said memory module; and
provides a memory module interface at a clock rate based on said obtained information.

41. A memory controller comprising a memory module interface to at least one memory module, said memory module including serial presence detect memory; wherein said memory controller:
accesses serial presence detect memory;
generates multiple clock frequencies;
obtains information from said serial presence detect memory; and
selects one of said clock frequencies for driving said memory module interface based on said obtained information.

42. The memory controller of claim 41 wherein said obtained information comprises a speed grade of said memory module.

43. Apparatus for selecting an operating speed of a memory module interface in a computer system, said system comprising a central processing unit, a memory controller, and at least one memory module comprising a serial presence detect memory, said apparatus comprising:
means for counting the number of said memory modules;
means for generating multiple clock frequencies to provide selectable operating speeds of said memory interface; and
means for selecting one of said multiple clock frequencies to provide an operating speed in accordance with said counted memory modules.

44. The apparatus of claim 43 wherein said selecting comprises means for generating memory module interface signals comprising clock, address, and data signals at a frequency based on said memory module count.

45. The apparatus of claim 43 further comprising means for obtaining information from said serial presence detect memory, said information including at least one characteristic of said memory module; wherein said means for selecting selects one of said multiple clock frequencies in accordance with at least one of said number of counted memory modules and said obtained information

46. The apparatus of claim 43 wherein said characteristic comprises the number of components in each said memory module.

47. The apparatus of claim 43 wherein said characteristic comprises a speed grade of said memory module.

48. The apparatus of claim 43 wherein said characteristic comprises a manufacturer of said memory module.

49. The apparatus of claim 43 wherein said characteristic comprises a type of said memory module.

50. The apparatus of claim 43 wherein said characteristic comprises a physical layout of signal connections between said memory controller and said memory module.

51. Apparatus for selecting an operating speed of a memory module interface in a computer system, said system comprising a central processing unit, a memory controller, and at least one memory module comprising a serial presence detect memory, said apparatus comprising:
means for counting the number of said memory modules;
means for obtaining information from said serial presence detect memory that includes at least one characteristic of said memory module; and
means for selecting said operating speed of said memory module interface in accordance with at least one of said means for counting and obtaining information.

52. Apparatus for selecting an operating speed of a memory module interface in a computer system, said system comprising a central processing unit, a memory controller, and at least one memory module comprising a serial presence detect memory, said apparatus comprising:
means for counting the number of said memory modules;
means for obtaining information from said serial presence detect memory that includes at least the number of components in each said memory module; and
means for selecting said operating speed of said memory module interface in accordance with at least one of said means for counting and obtaining information.

53. Apparatus for selecting an operating speed of a memory module interface in a computer system, said system comprising a central processing unit, and a memory controller, and at least one memory module comprising a serial presence detect memory, said apparatus comprising:
means for counting the number of said memory modules;
means for obtaining information from said serial presence detect memory that includes at least a speed grade of said memory module; and
means for selecting said operating speed of said memory module interface in accordance with at least one of said means for counting and obtaining information.
